(19) United States
(12) Patent Application Publication
(10) Pub. No.: US 2015/0127369 A1
(43) Pub. Date: May 7, 2015

(54) SYSTEMS AND METHODS FOR DRUG-DELIVERY TECHNOLOGY SELECTION

(71) Applicant: R.P. Scherer Technologies, LLC, Carson City, NV (US)

(72) Inventors: Rao Hanumantharao Tatapudy, Suffern, NY (US); David Harlan Igo, Raleigh, NC (US); Joseph Angelo Montano, Somerset, NJ (US); Jonathan Ki-Chi Tam, Trenton, NJ (US); Kurt Nielsen, Chads Ford, PA (US)

(21) Appl. No.: 14/533,086

(22) Filed: Nov. 4, 2014

Related U.S. Application Data
(60) Provisional application No. 61/899,474, filed on Nov. 4, 2013.

(51) Int. Cl. G06F 19/00

(52) U.S. Cl. CPC G06F 19/3456
USPC 705/2

(57) ABSTRACT

Currently there is no conventional tool kit/method available to determine the most appropriate drug delivery technology for a drug molecule. Instead, different drug delivery options are investigated through actual experimentation, and the most appropriate drug delivery technology is selected based on trial and error. Embodiments of the current disclosure provide an innovative, unique, versatile, all-inclusive tool kit/method for one or more appropriate delivery technologies to be recommended by a drug-technology company providing those technologies to a customer for a given drug molecule based on the characteristics of a the drug molecule provided as input.

### CROSS-REFERENCE TO RELATED APPLICATION

This application claims priority to co-pending U.S. Provisional Patent Application Ser. No. 61/899,474, filed Nov. 4, 2013, the disclosure of which is incorporated herein by reference in its entirety.

### FIELD OF THE DISCLOSURE

The present disclosure relates generally to pharmaceuticals, and, in particular, to drug-delivery technologies.

### BACKGROUND

Drug delivery is the administration of a pharmaceutical compound (to a human or other animal) to achieve a therapeutic effect. Drug delivery involves choosing approaches, formulations, technologies, and systems for safely achieving a desired therapeutic effect by transporting a pharmaceutical compound, either at a specific site or systemically, within the body. A drug manufacturer exercises control over the quantity and duration of a drug's presence in the body and uses various technologies in connection with a given chemical formulation to achieve both efficacy and safety.

In addition to one or more active ingredients, a drug may further include additional diluents, binders, lubricants, colorings, flavorings, and/or disintegrates.

Numerous technologies exist for delivering a drug product, and new technologies are constantly being developed. Such technologies include, e.g., buccal tablets or film, capsules, chewing gums, chewable tablets, diluents, elixirs, enemas, enteric-coated tablets, gel capsules, liquids, lotions, lozenges, lollipops, inhalers, ointments, transdermal patches, powders, solutions, sprays, suppositories, suspensions, syrups, tablets, tinctures, and troches. A number of these technologies involve time-release mechanisms (also called sustained release (SR), sustained action (SA), extended release (ER), timed release (TR), controlled release (CR), modified release (MR), or continuous release), permitting tablets or capsules to deliver a drug into the bloodstream in a controlled manner over time, while reducing the frequency of intervals relative to conventional dosage formulations of the same drug.

Each drug-delivery technology has its own features, limitations, advantages, and disadvantages. Given the same drug, different technologies can offer varying degrees of control over drug delivery, depending on a number of factors. Such factors include, e.g., dissolution rate, saturation solubility, solubility, permeability, bioavailability, degradation by the gastrointestinal tract (e.g., acid or bacterial flora), food interactions, absorbability, patient convenience, patient discomfort, patient compliance, patient education, self-administrability, invasiveness, unit dosage form, cost, speed of action, enzymatic activity, effects of first-pass metabolism, sterility, toxicity, optimal delivery, accurate dosage, target-specific delivery, time-controlled release, multiple dosing, side effects, and the like.

Selecting an appropriate dosage form involves a complex process that includes analysis and consideration of multiple physical, chemical, and biologic characteristics of one or more drug molecules, one or more other pharmaceutical ingredients, and one or more possible drug-delivery technologies. Conventionally, this process may involve some degree of guesswork or trial-and-error and typically relies on a scientist, technician, or other human actor, who selects drug-delivery technologies while attempting to take into account a large number of variables. Without the requisite technical background, an individual attempting to select an appropriate drug-delivery technology faces countless opportunities for mistake, and it can be difficult or impossible to consider all of the critical parameters in making a sound selection, even for those in the pharmaceutical industry due to ever-changing drug-delivery technology offerings.

### SUMMARY

Embodiments of the disclosure provide systems and methods for one or more appropriate delivery technologies to be recommended for a given drug based on characteristics of a molecule provided as input, such as by a customer of a drug-technology company providing those delivery technologies.

### BRIEF DESCRIPTION OF THE DRAWINGS

FIG. 1 is a block diagram showing an exemplary drug-delivery technology recommendation server system, consistent with one embodiment of the disclosure;

FIG. 2 is a process flow diagram for the drug-delivery technology recommendation server of FIG. 1 to recommend a drug-delivery technology, in one exemplary embodiment of the disclosure;

FIGS. 3 through 25 graphically illustrate various screen views of an exemplary web browser using the drug-delivery technology recommendation server of FIG. 1, in one embodiment of the disclosure;

FIGS. 26(a) through 29(e) are collectively a four-page spreadsheet for implementing an exemplary method for recommending a drug-delivery technology, in one embodiment of the disclosure.

### DETAILED DESCRIPTION

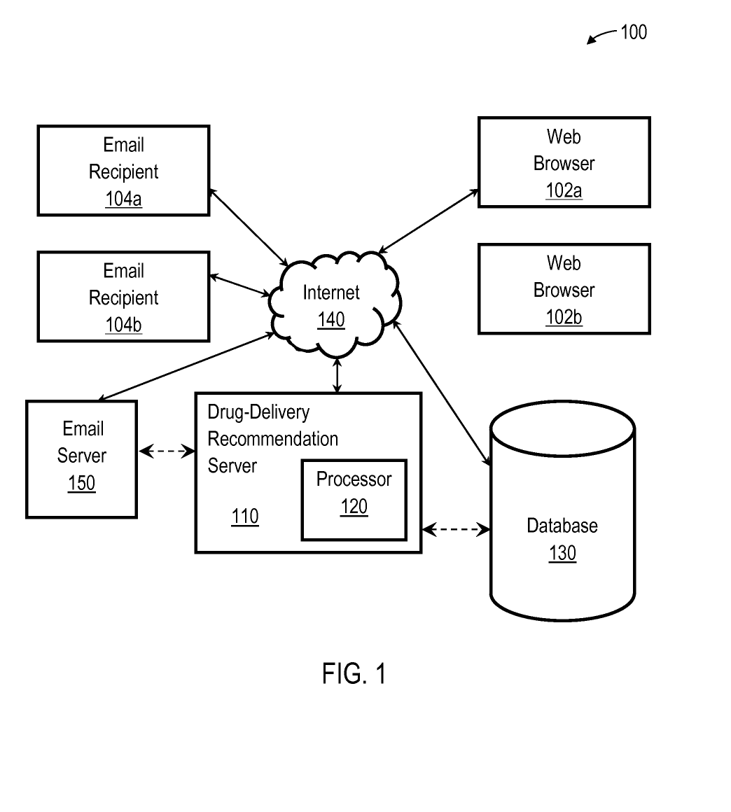

FIG. 1 shows an exemplary system 100 for recommending a drug-delivery technology, consistent with one embodiment of the disclosure. As shown, system 100 includes a drug-delivery technology recommendation server 110 having a processor 120 and coupled to an email server 150 and a database 130, e.g., directly, via a local-area network (LAN), or via the Internet 140. Processor 120 is adapted to execute program code, as described in further detail below, to perform the functionality of web server 110 described herein. A plurality of individual users access the web server 110 via the Internet 140, e.g., via respective web browsers 102a, 102b. Other users may be email recipients 104a, 104b who receive information via the Internet 140, which may be sent by email server 150 in the form of standard email messages.

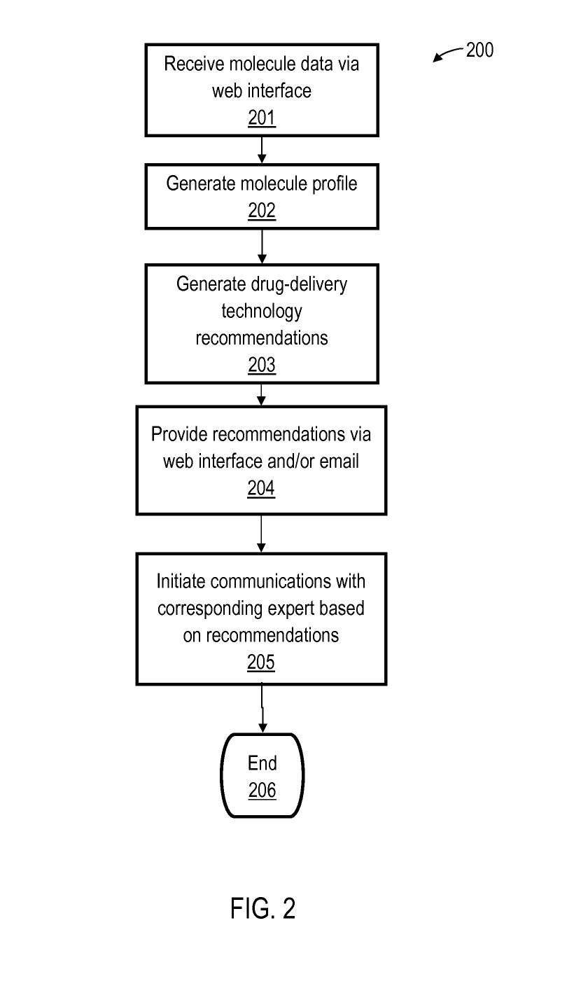

FIG. 2 shows an exemplary process flow 200 for the drug-delivery technology recommendation server 110 of FIG. 1 to recommend a drug-delivery technology, in one embodiment of the disclosure. As shown, process 200 begins at step 201 with drug-delivery technology recommendation server 110 receiving data about a target molecule, e.g., from a customer of a drug-technology company, via a web interface. Next, at step 202, a molecule profile is generated based on the received molecule data. Next, at step 203, drug-delivery technology recommendations are generated based on the molecule profile and data stored in the database, using a method as described in further detail below. At step 204, those recommendations are provided to the customer via the web interface and/or email. At step 205, communications with the customer is initiated with a corresponding expert (e.g., via real-time audio, video, and/or text chat interface, via telephone, or via email) based on those recommendations. The process ends at step 206.

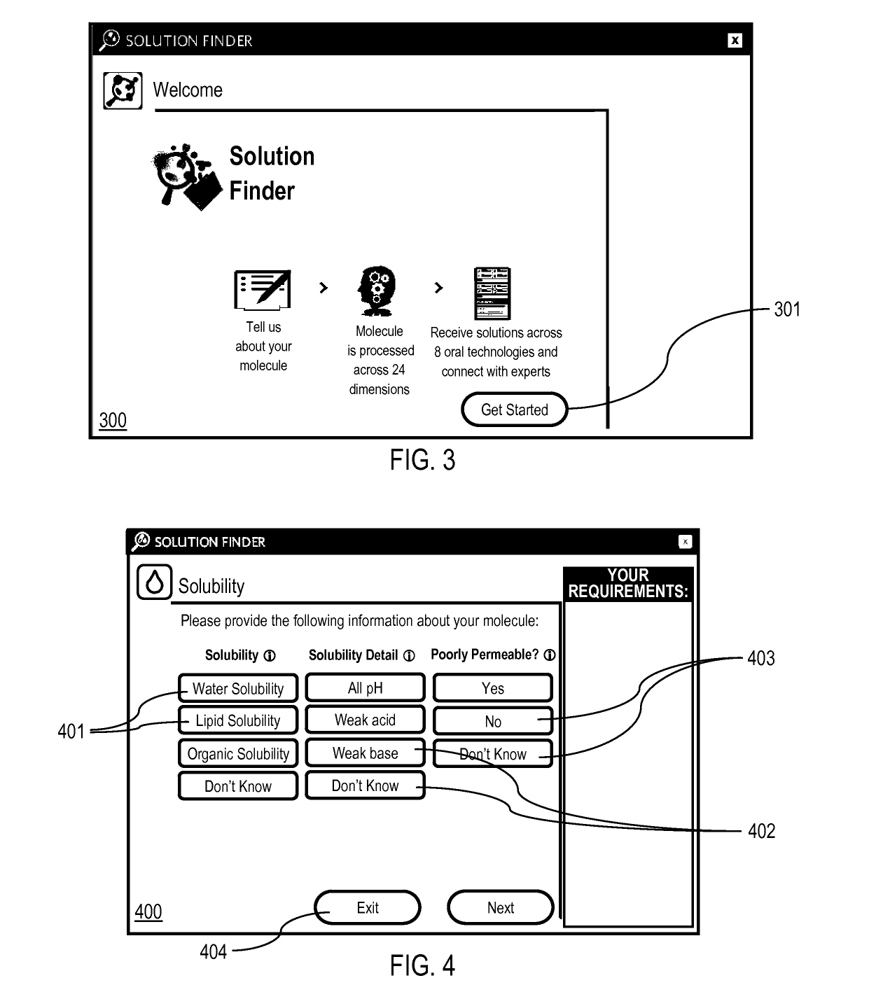

Details of the foregoing steps of process 200, in one exemplary embodiment, will now be described with reference to FIGS. 3 through 25, which graphically illustrate various screen views of an exemplary web-based method for recommending a drug-delivery technology. Although a user will typically be presented with the “screens” (or “screen views”) of FIGS. 3 through 25 in the sequence in which those views are presented herein, it should be understood that other sequences are possible, and that some views will be added, omitted, rearranged, or modified, in certain embodiments. It should also be understood that additional or alternative text and/or graphic content may be employed to achieve similar, alternative, or additional functionality, in embodiments of the disclosure.

FIG. 3 shows an exemplary “welcome” screen 300. Screen 300 provides the user with a brief overview of the process for generating and processing a molecule profile and receiving a drug-delivery technology recommendation. A “get started” button 301 is included, which the user selects to begin the process. As will be described in further detail below, drug-delivery technology recommendation server 110 presents a series of interface screens to the user, e.g., a customer of a drug-technology company, who provides data about a target molecule via the web interface. In some embodiments, publicly available data associated with a drug molecule may be pre-supplied by drug-delivery technology recommendation server 110 at the user's request.

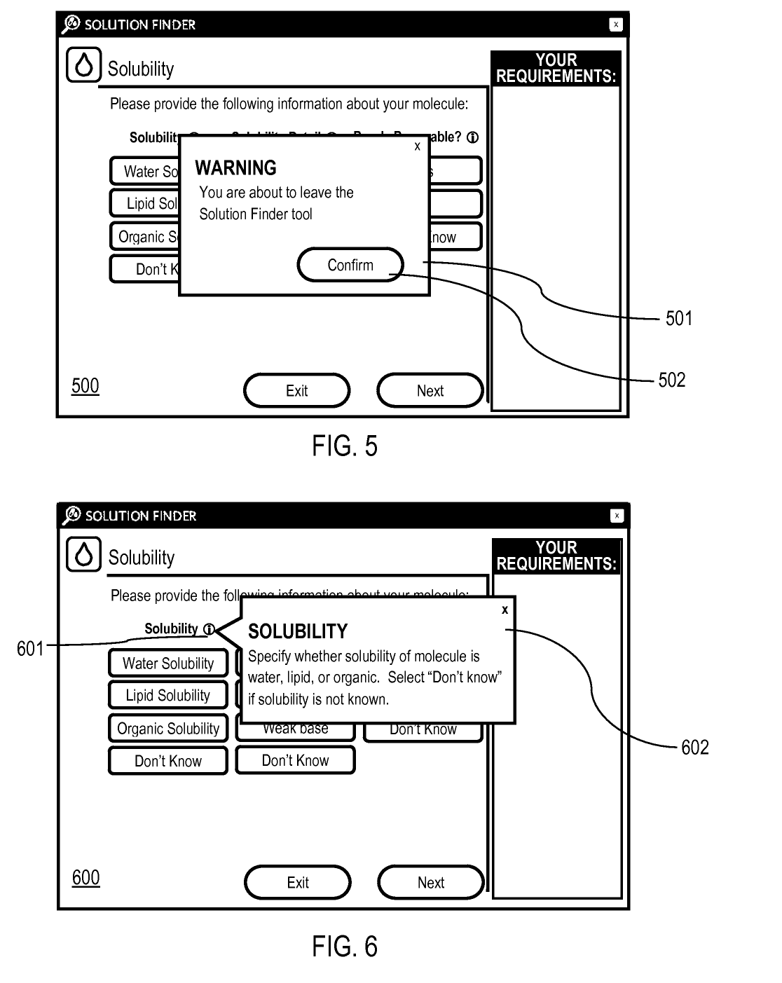

Initially, as shown in FIG. 4, an exemplary “solubility” screen 400 is presented, which queries the user to select buttons to provide responses for three items of information requested, namely, solubility 401 (water, lipid, organic, don't know), solubility detail 402 (all pH, weak acid, weak base, don't know), and poor permeability 403 (yes, no, don't know). If the user selects the “exit” button 404, then the user is taken to a screen view such as screen 500 of FIG. 5. A similar “exit” button appears on other screen views described herein and functions in like manner to button 404.

FIG. 5 shows an exemplary warning screen 500, which provides a confirmation dialogue 501 to the user when the user is about to exit process 200 altogether, prompting the user to press the “confirm” button 502 to exit.

As shown in the exemplary screen view 600 of FIG. 6, if the user clicks on the “i” (information) button 601 adjacent to an item (e.g., the “Solubility” selections), an additional information balloon 602 appears and provides additional information regarding the choices for which the user is being prompted, to assist the user in making a selection.

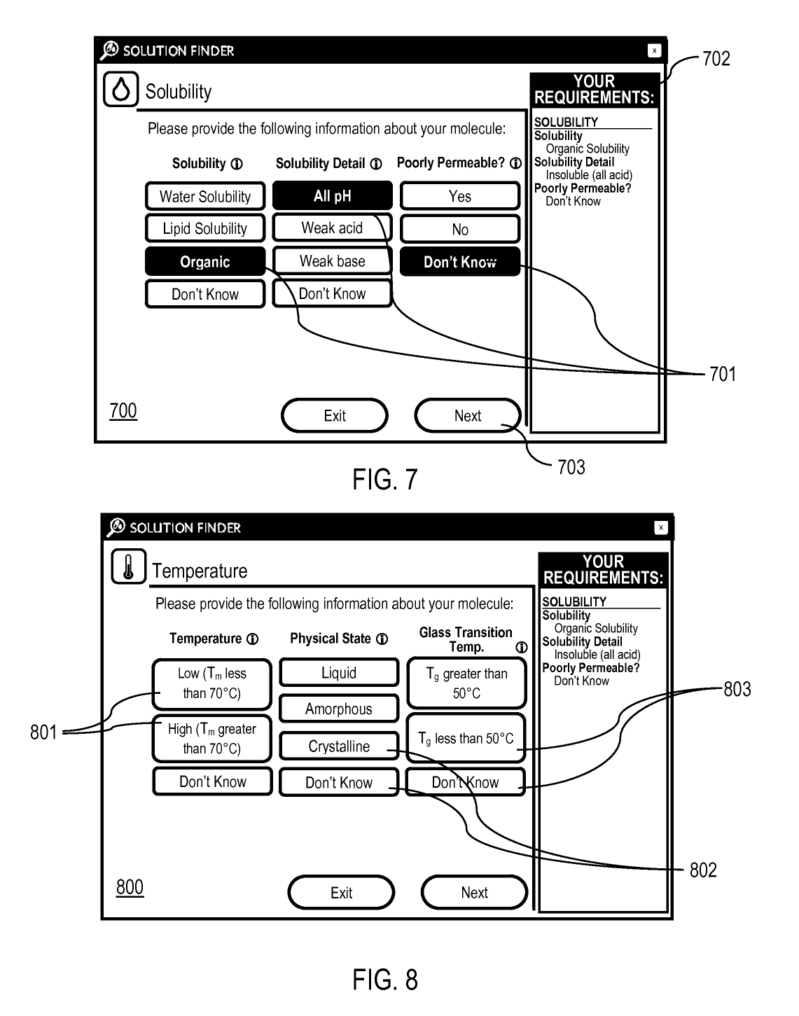

Screen view 700 of FIG. 7 shows screen view 400 of FIG. 4 after the user has provided responses for the three items of information requested. For confirmation, those responses are displayed both by highlighting the buttons 701 selected by the user and in a “Your Requirements” panel 702, which provides a scrollable running display, in a view area at the right portion of the screen, of all criteria selections made by the user during the entire process 200 thus far. The “Your Requirements” panel 702 appears on other screen views herein as well. If the user selects the “next” button 703, then the user is taken to screen view 800 of FIG. 8.

FIG. 8 shows an exemplary “temperature” screen 800, which queries the user to provide responses for three items of information requested, namely, temperature 801 (low—less than 70 degrees C., high—greater than 70 degrees C., don't know), physical state 802 (liquid, amorphous, crystalline, don't know), and glass transition temperature 803 (T_{g} greater than 50 degrees C., T_{g} less than 50 degrees C., don't know).

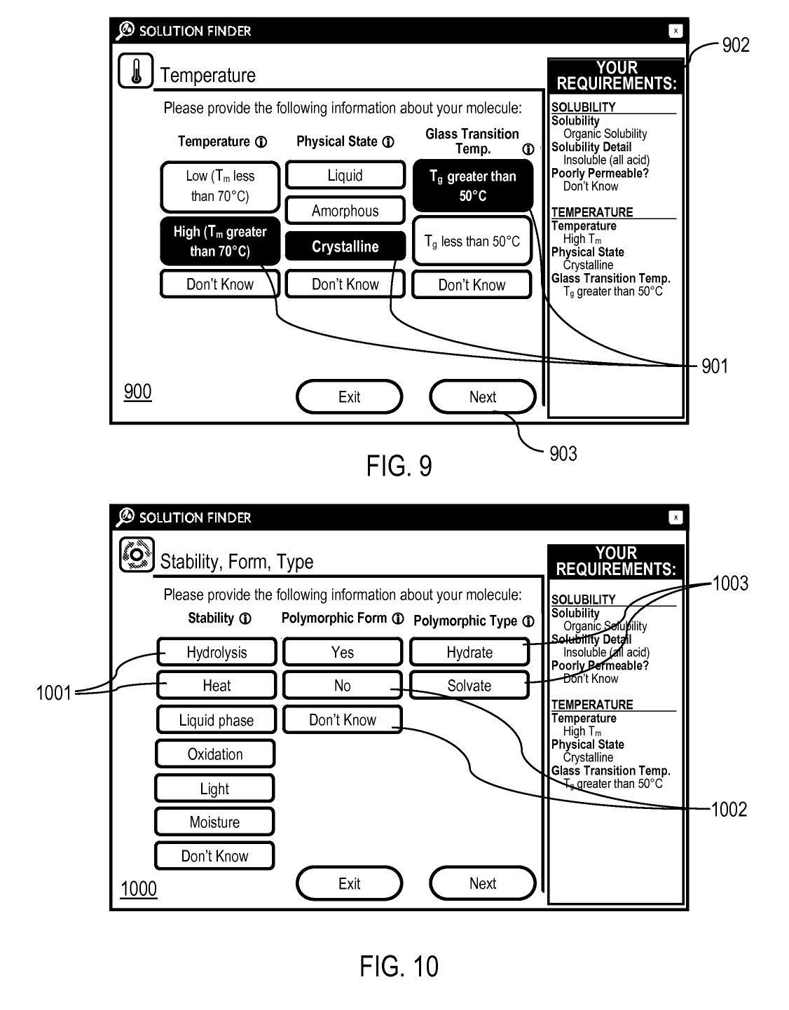

Screen view 900 of FIG. 9 shows screen view 800 of FIG. 8 after the user has provided responses for the three items of information requested, which are shown by highlighted buttons 901 and in “Your Requirements” panel 902, which provides a scrollable running display, in a view area at the right portion of the screen, of all criteria selections made by the user during the entire process 200 thus far. If the user selects the “next” button 903, then the user is taken to screen view 1000 of FIG. 10.

FIG. 10 shows an exemplary “stability, form, type” screen 1000, which queries the user to provide responses for three items of information requested, namely, stability 1001 (hydrolysis, heat, liquid phase, oxidation, light, moisture, don't know), polymorphic form 1002 (yes, no, don't know), and polymorphic type 1003 (hydrate, solvate).

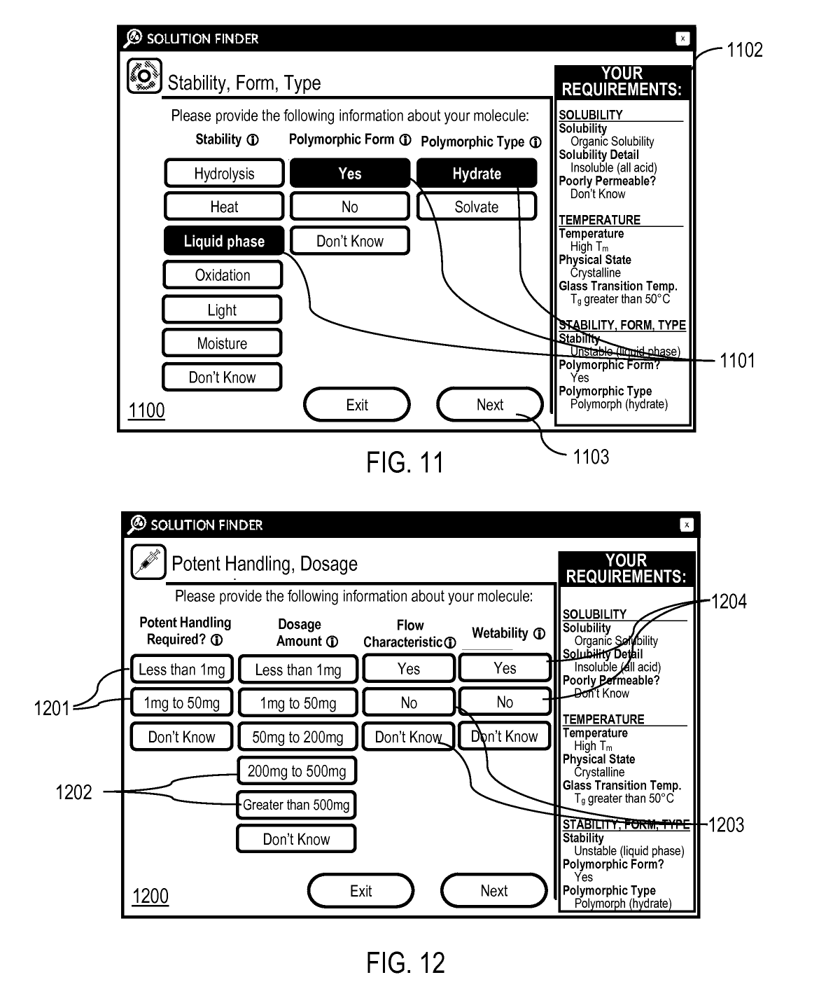

Screen view 1100 of FIG. 11 shows screen view 1000 of FIG. 10 after the user has provided responses for the three items of information requested, which are shown by highlighted buttons 1101 and in “Your Requirements” panel 1102, which provides a scrollable running display, in a view area at the right portion of the screen, of all criteria selections made by the user during the entire process 200 thus far. If the user selects the “next” button 1103, then the user is taken to screen view 1200 of FIG. 12.

FIG. 12 shows an exemplary “potent handling, dosage” screen 1200, which queries the user to provide yes/no/don't know responses for four items of information requested, namely, potent handling required 1201 (less than 1 mg, 1 to 50 mg, don't know), dosage amount 1202 (less than 1 mg, 1 to 50 mg, 50 to 200 mg, 200 to 500 mg, greater than 500 mg, don't know), flow characteristic 1203 (yes, no, don't know), and wetability 1204 (yes, no, don't know).

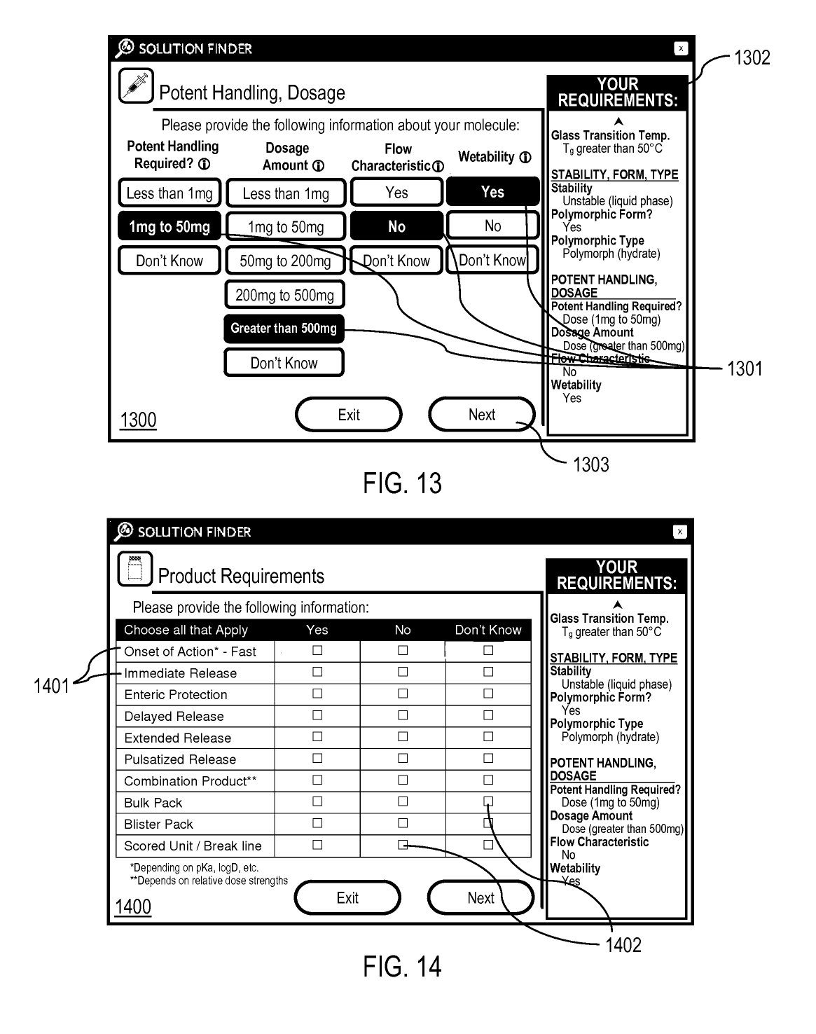

Screen view 1300 of FIG. 13 shows screen view 1200 of FIG. 12 after the user has provided responses for the four items of information requested, which are shown by highlighted buttons 1301 and in “Your Requirements” panel 1302, which provides a scrollable running display, in a view area at the right portion of the screen, of all criteria selections made by the user during the entire process 200 thus far. If the user selects the “next” button 1303, then the user is taken to screen view 1400 of FIG. 14.

FIG. 14 shows an exemplary “product requirements” screen 1400, which queries the user to provide yes/no/don't know responses for ten items 1401 of information requested, by selecting the corresponding check boxes 1402. The items 1401 of information include, e.g., fast onset of action, immediate release, enteric protection, delayed release, extended release, pulsatized release, combination product, bulk pack blister pack, and scored unit/brake line.

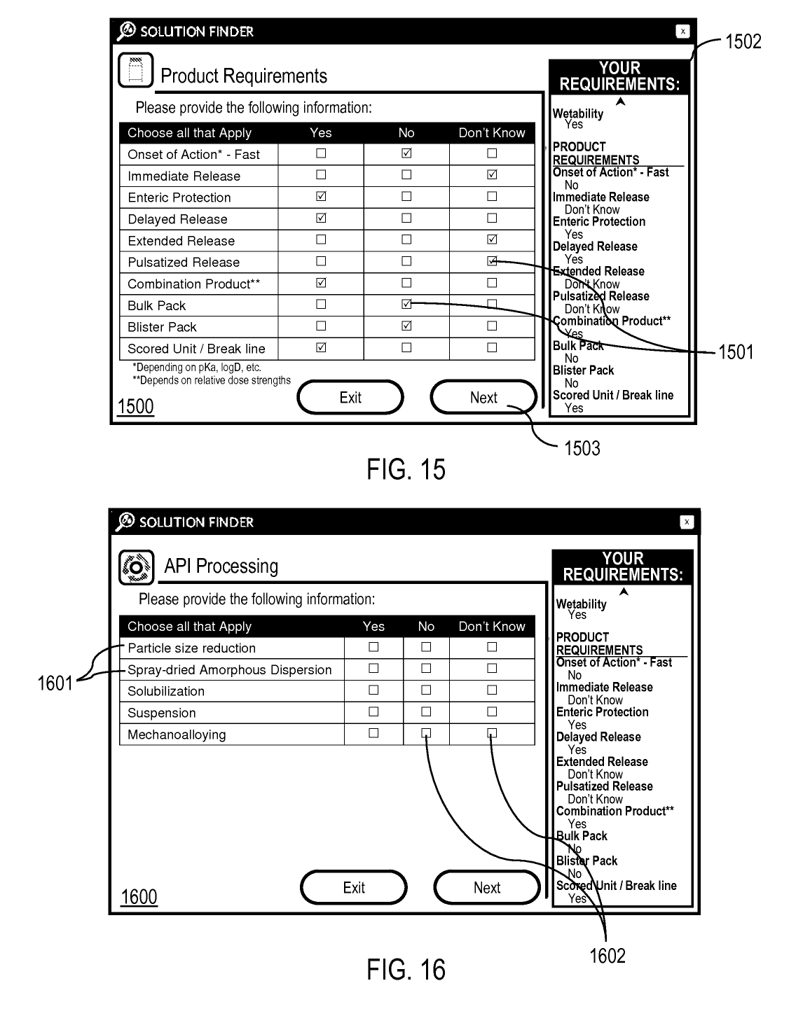

Screen view 1500 of FIG. 15 shows screen view 1400 of FIG. 14 after the user has provided responses for the ten items of information requested, which are shown by checked boxes 1501 and in “Your Requirements” panel 1502, which provides a scrollable running display, in a view area at the right portion of the screen, of all criteria selections made by the user during the entire process 200 thus far. If the user selects the “next” button 1503, then the user is taken to screen view 1600 of FIG. 16.

FIG. 16 shows an exemplary “Active pharmaceutical ingredient (API) processing” screen 1600, which queries the user to provide yes/no/don't know responses for five items 1601 of information requested, by selecting the corresponding check boxes 1602. The items 1601 of information include, e.g., particle-size reduction, spray-dried amorphous dispersion, solubilization, suspension, and mechanoalloying.

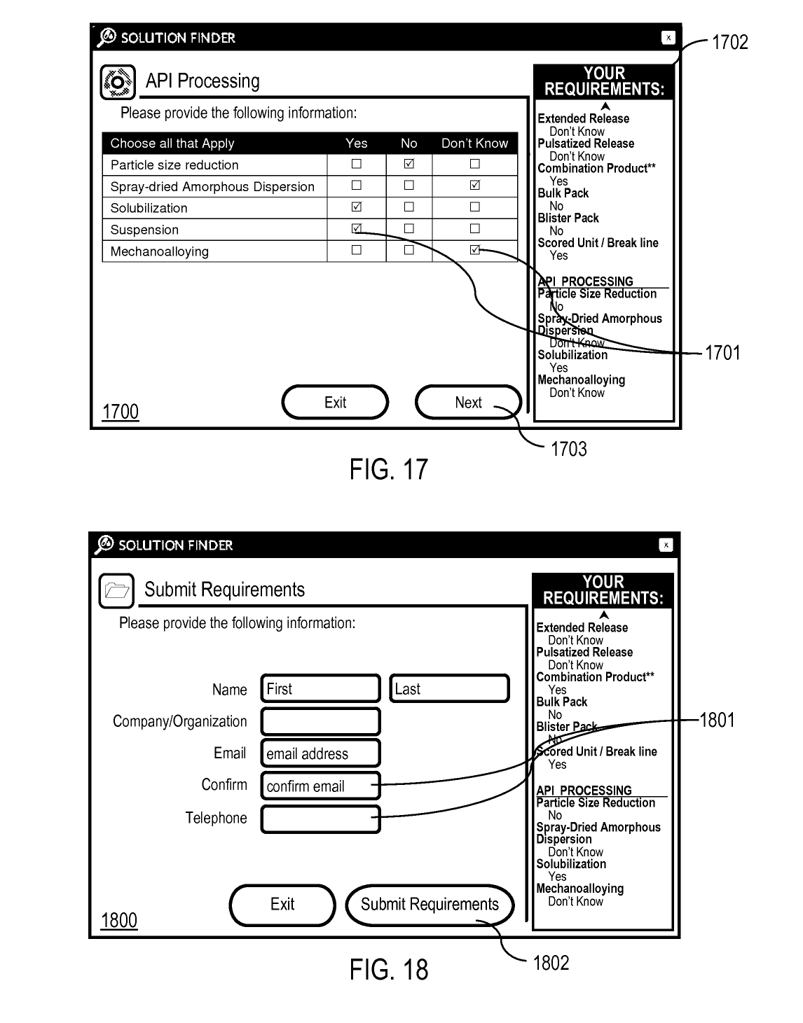

Screen view 1700 of FIG. 17 shows screen view 1600 of FIG. 16 after the user has provided responses for the five items of information requested, which are shown by checked boxes 1701 and in “Your Requirements” panel 1702, which provides a scrollable running display, in a view area at the right portion of the screen, of all criteria selections made by the user during the entire process 200 thus far. If the user selects the “next” button 1703, then the user is taken to screen view 1800 of FIG. 18.

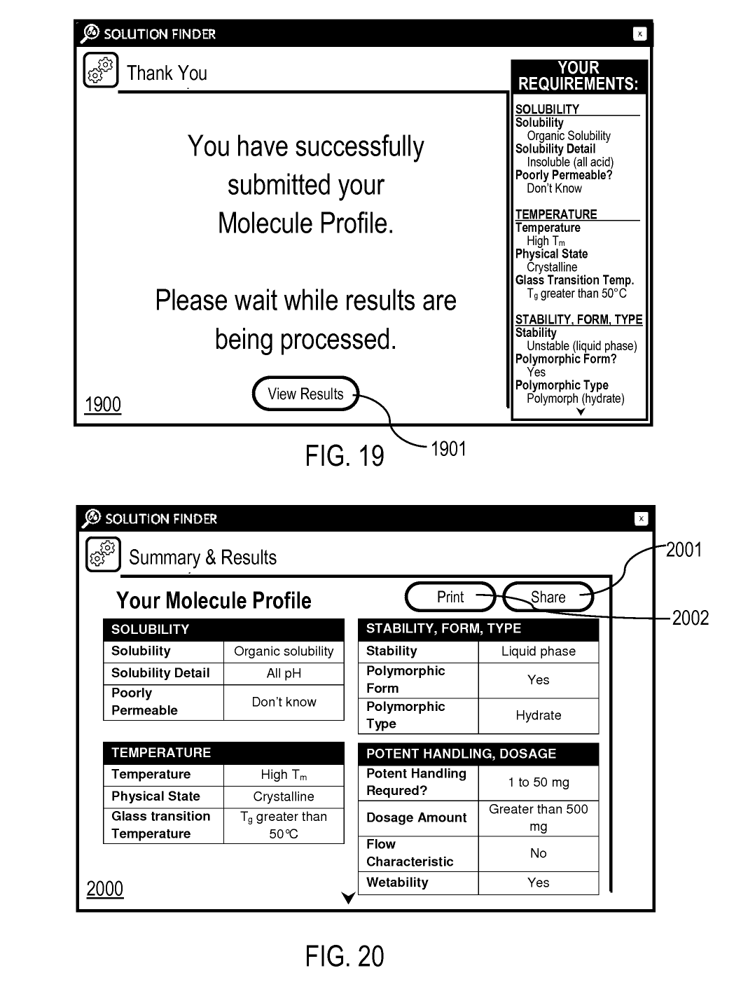

FIG. 18 shows an exemplary “submit requirements” screen 1800, which queries the user to provide, in fields 1801, various contact information, including, e.g., name, company/organization, email address, and telephone number, so that the user, e.g., a potential customer, can be contacted by an expert or other representative of the drug-technology company capable of providing the subject drug-delivery technologies. If the user selects the “submit requirements” button 1802, then the user is taken to screen view 1900 of FIG. 19.

FIG. 19 shows an exemplary “thank you” screen 1900, which confirms that the user's input molecule characteristics have been received and are being processed and prompts the user to wait for the results to be generated. Once the results have been generated, a “view results” button 1901 appears. If the user selects the “view results” button 1901, then the user is taken to screen view 2000 of FIG. 20.

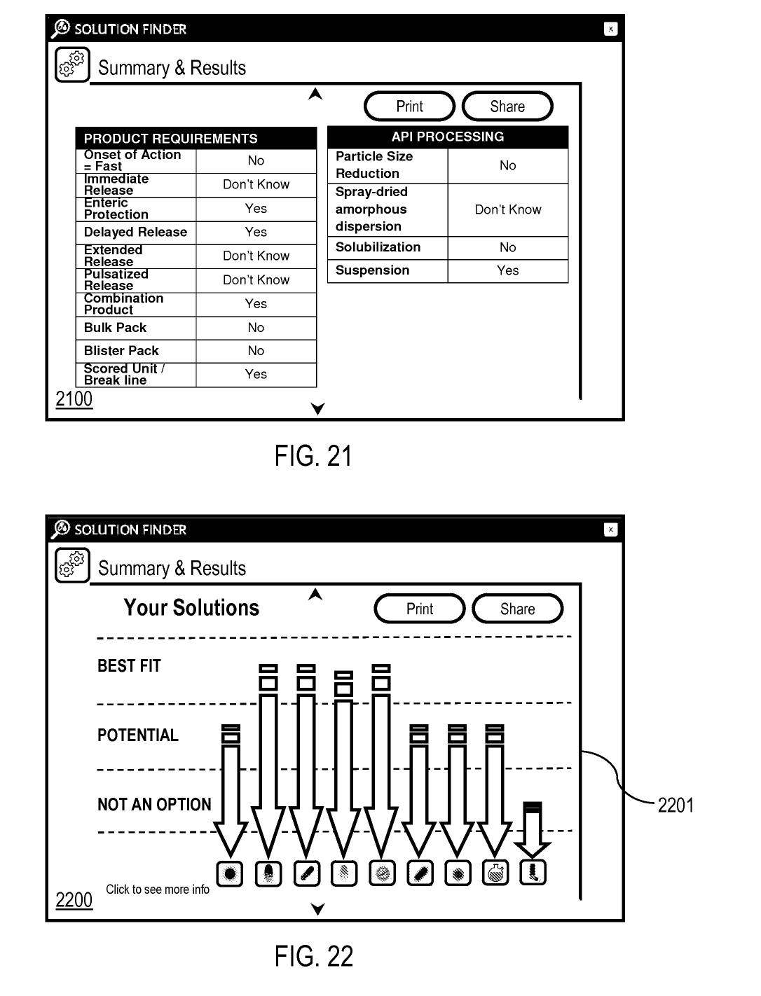

FIGS. 20-23 collectively show first 2000, second 2100, third 2200, and fourth 2300 portions, respectively, of an exemplary report screen, which includes a summary of the molecule profile information that was provided as input, together with recommended solutions. Screen view 2000 of FIG. 20 displays a first portion of the information entered by the user, and screen view 2100 of FIG. 21 displays a second portion of the information entered by the user. A “share” button 2001 enables sharing, e.g., via email (e.g., using email server 150) or social media platform, of the displayed screen and/or all four screens 2000, 2100, 2200, 2300 of the report. A “print” button 2002 enables printing of the displayed screen and/or all four screens 2000, 2100, 2200, 2300 of the report.

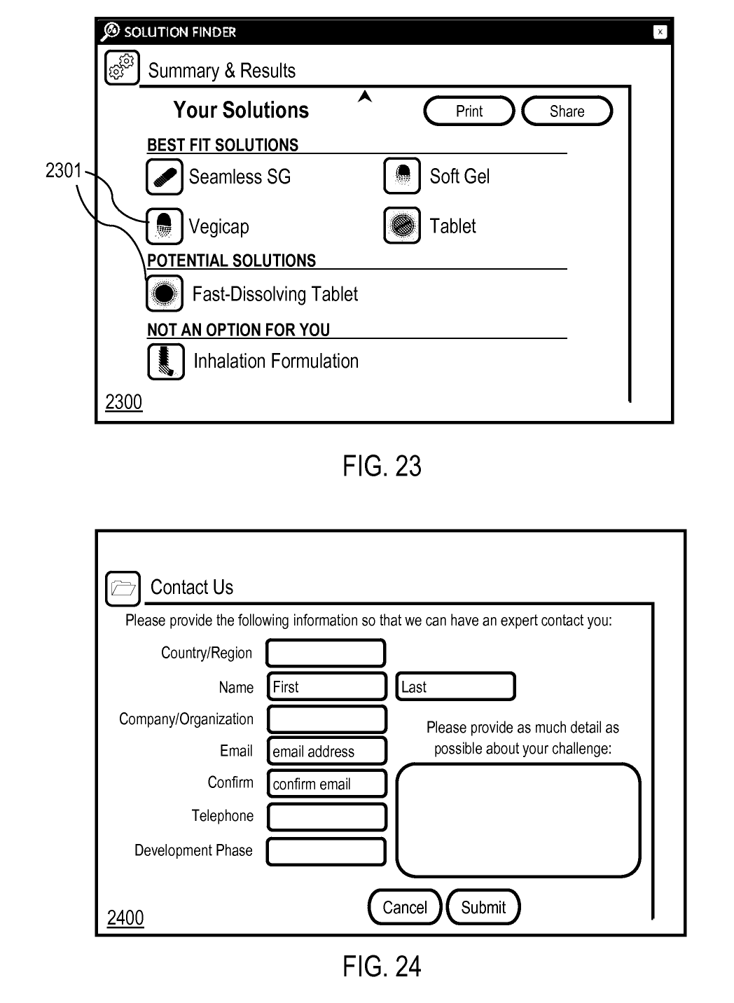

Screen view 2200 of FIG. 22 displays a first portion of the results provided by drug-delivery technology recommendation server 110, and screen view 2300 of FIG. 23 displays a second portion of those results. As shown, drug-delivery technology recommendation server 110 classifies the recommended solutions into “best fit,” “potential,” and “not an option” categories, with the solutions in this exemplary embodiment selected from among eight possible drug-delivery options, namely, Soft Gel (SG) (lipid/polymer-based immediate release (IR)/modified release (MR)), Optimelt® (polymer-based IR/MR/controlled delivery (CD), Optidose® (oral solid fast-dissolve (FD)/IR/MR/CD), Tablet (compressible oral solid IR), Capsule (oral solid IR), Vegicap® (lipid-based IR/MR), Seamless SG (lipid/polymer-based IR/MR), Zydis (oral solid FD), and Lyopan® (oral solid FD).

The “best fit” solutions are the solutions that are determined by drug-delivery technology recommendation server 110 to be optimal based on the molecule profile information provided. The “potential” solutions are the solutions that are determined by drug-delivery technology recommendation server 110 to be possible based on the molecule profile information provided, but not necessarily optimal. The “not an option” solutions are the solutions that are determined by drug-delivery technology recommendation server 110 not to be possible based on the molecule profile information provided.

In addition to being categorized as “best fit,” “potential,” and “not an option,” particular solutions may further be ranked within each of these categories, as shown in bar graph 2201 of screen view 2200 of FIG. 22. Screen view 2300 of FIG. 23 includes selection buttons 2301 provided for the user to view additional information (not shown) about each solution returned as a result.

FIG. 24 shows a screen view 2400 for providing post-result additional contact information, including name, company/organization, country/region, development phase, email address, telephone number, and a text box for free entry of additional information, so that the user, e.g., a potential customer, can be contacted by an expert or other representative of the drug-technology company capable of providing the subject drug-delivery technologies.

Now that one or more appropriate drug-delivery technologies have been identified that appear to meet the potential customer's requirements, drug-delivery technology recommendation server 110 can select an appropriate expert, scientist, or other representative from the drug-technology company's team to contact the potential customer, to make dealings most efficient.

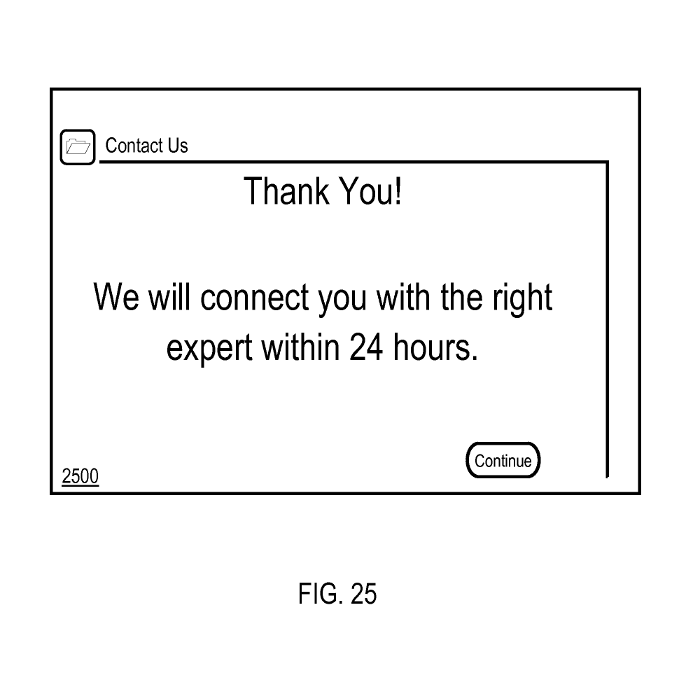

In one embodiment, the selected expert, scientist, or other representative is connected via electronic communications with the customer. This is initiated, e.g., via real-time audio, video, and/or text chat interface, via telephone, or via email. FIG. 25 shows a screen view 2500 thanking the user, indicating that the user's information has successfully been submitted to the drug-technology company, and confirming that the user will be contacted by an appropriate expert selected by drug-delivery technology recommendation server 110 shortly.

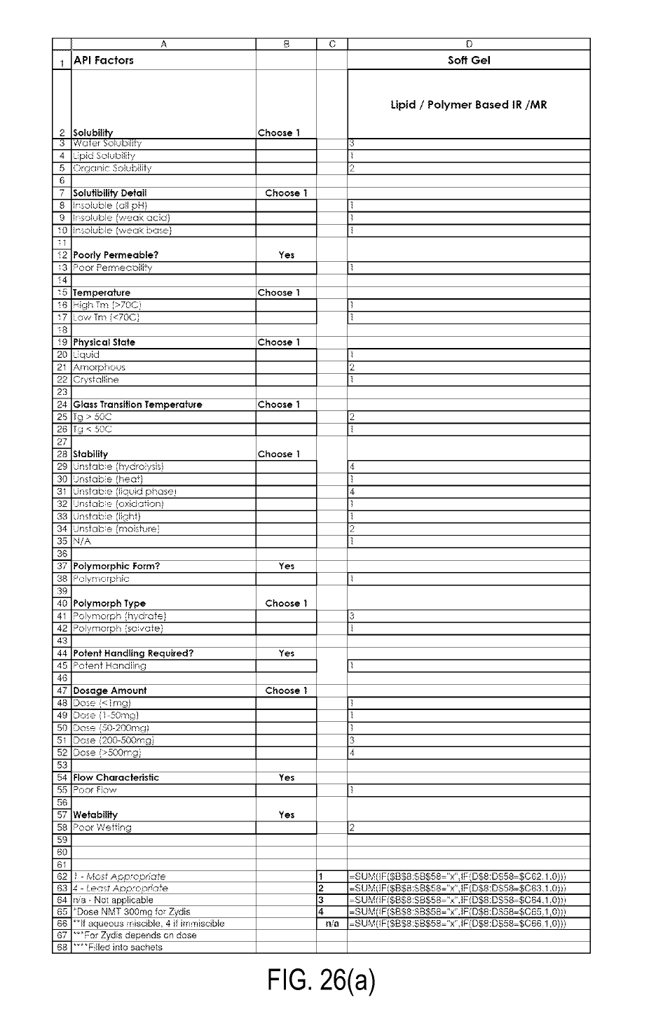

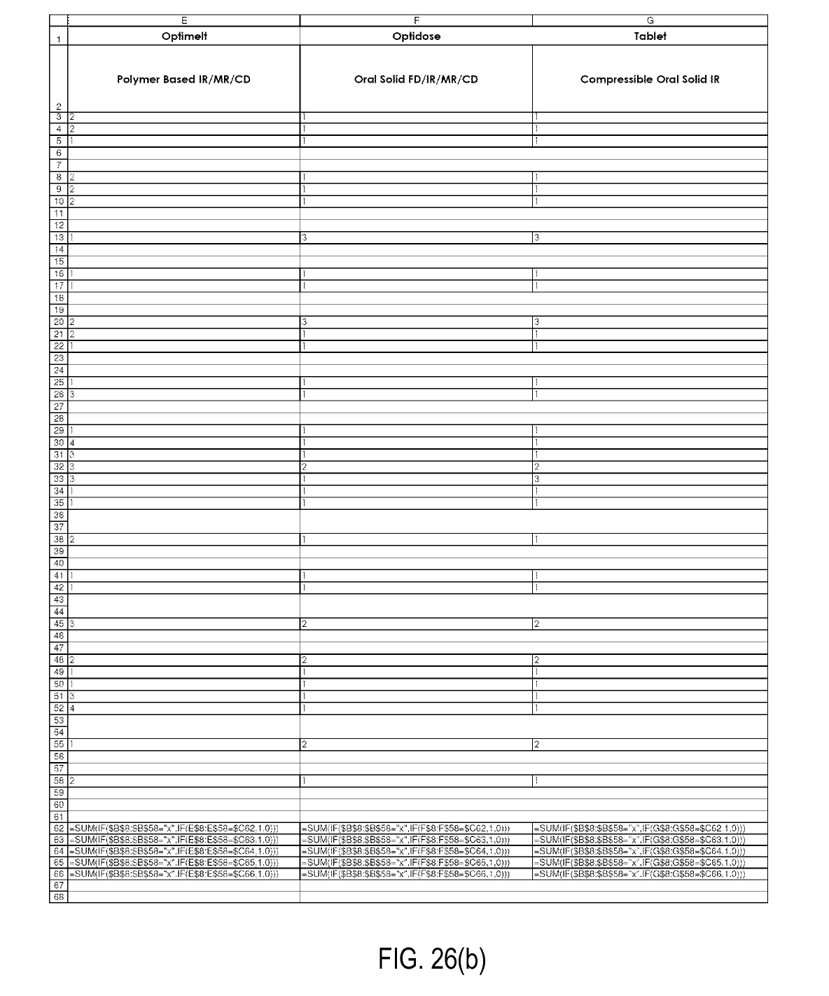

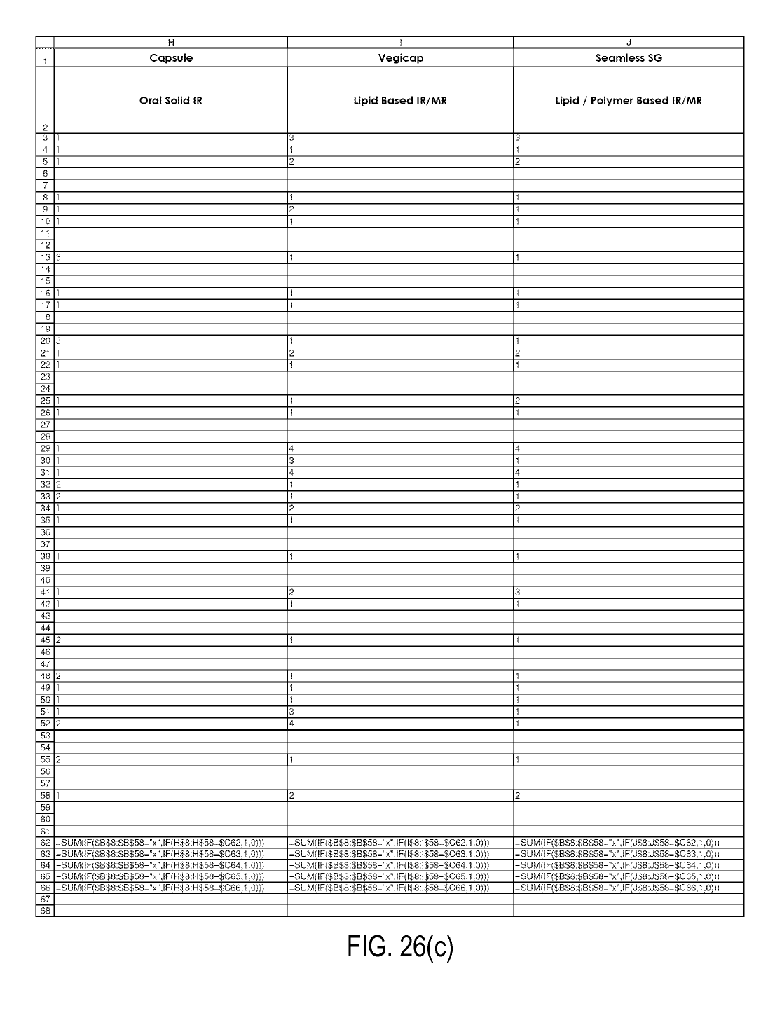

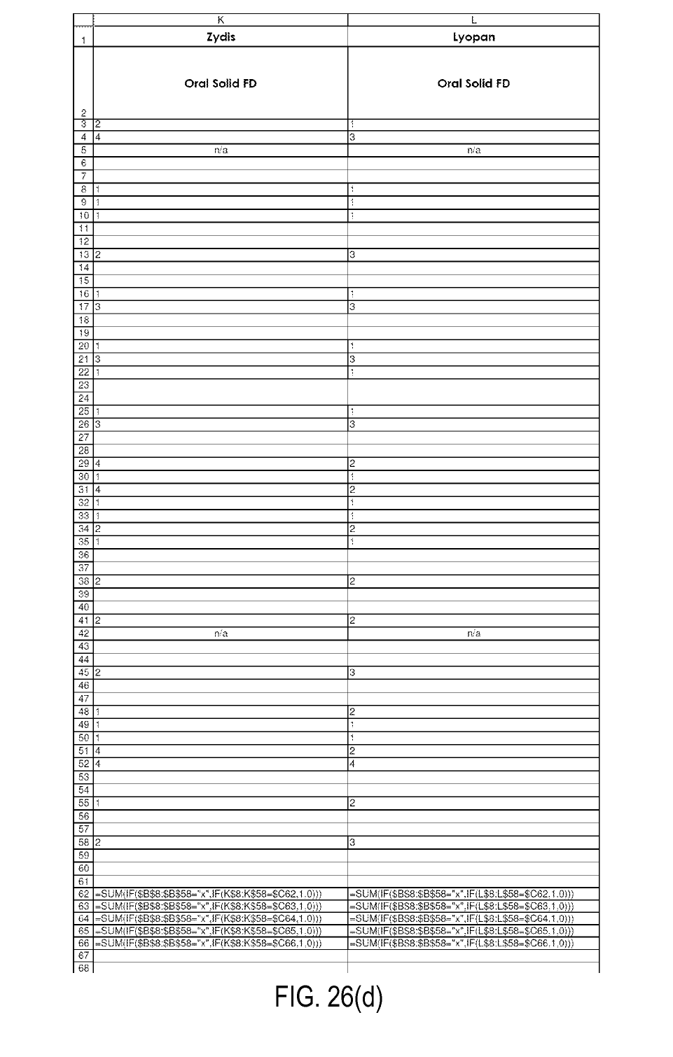

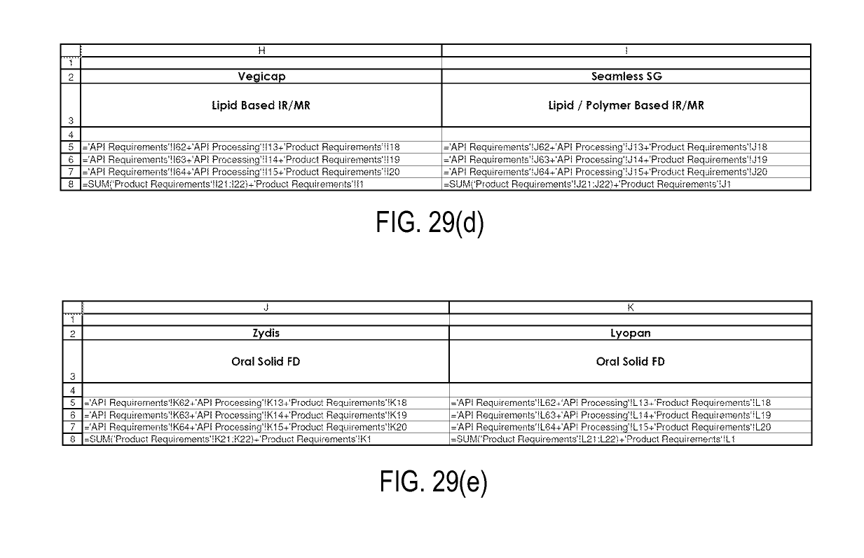

FIGS. 26(a) through 29(e) are collectively a four-page spreadsheet for implementing an exemplary method for recommending a drug-delivery technology, in one embodiment of the disclosure. It should be understood that this method can be implemented without the specific need for a separate database, since the spreadsheet itself contains all of the reference data used to make recommendations for one or more appropriate drug-delivery technologies.

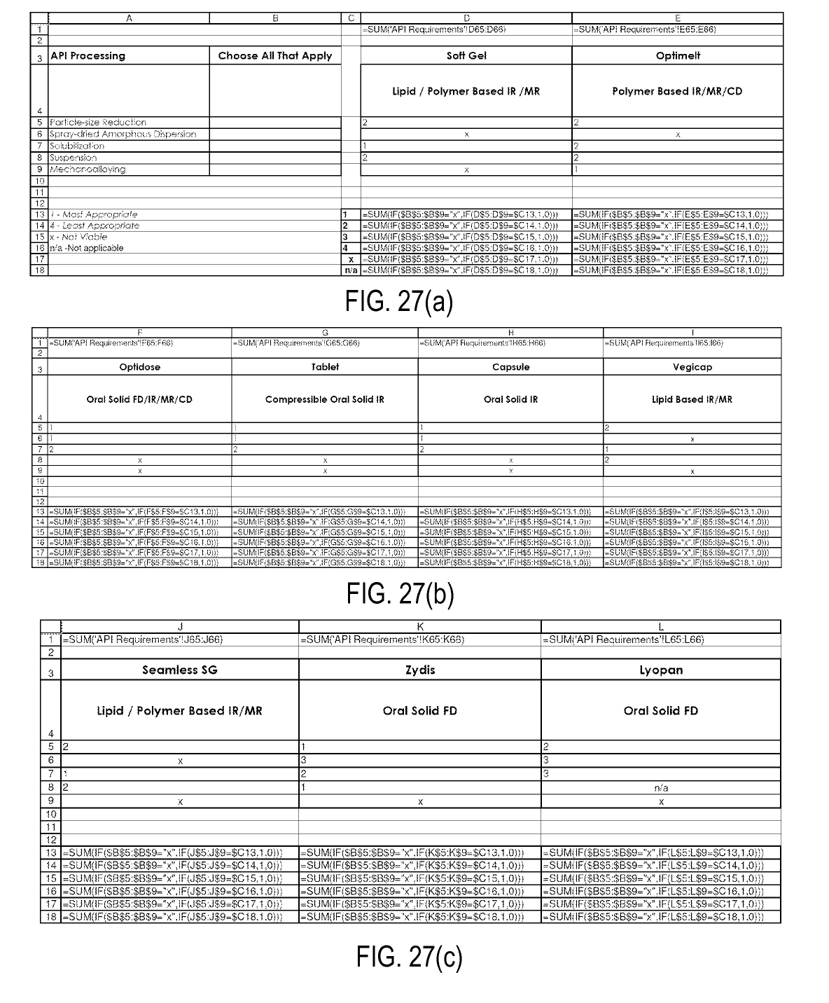

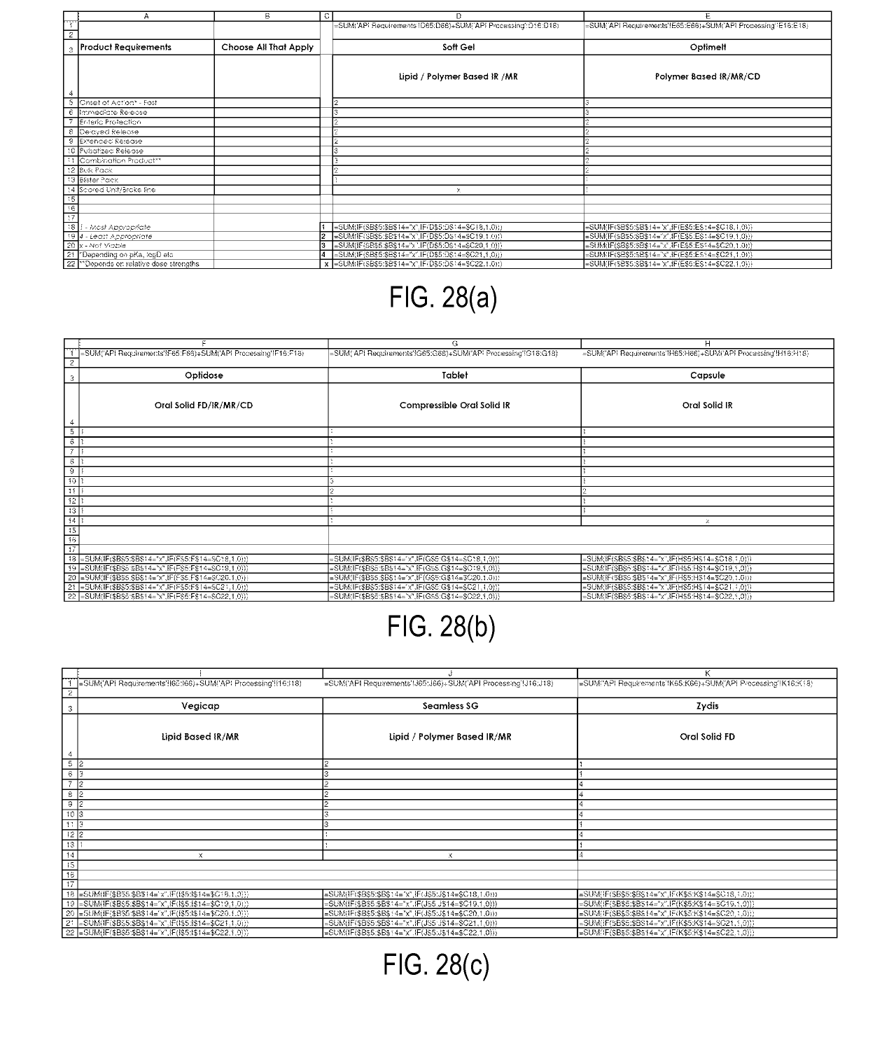

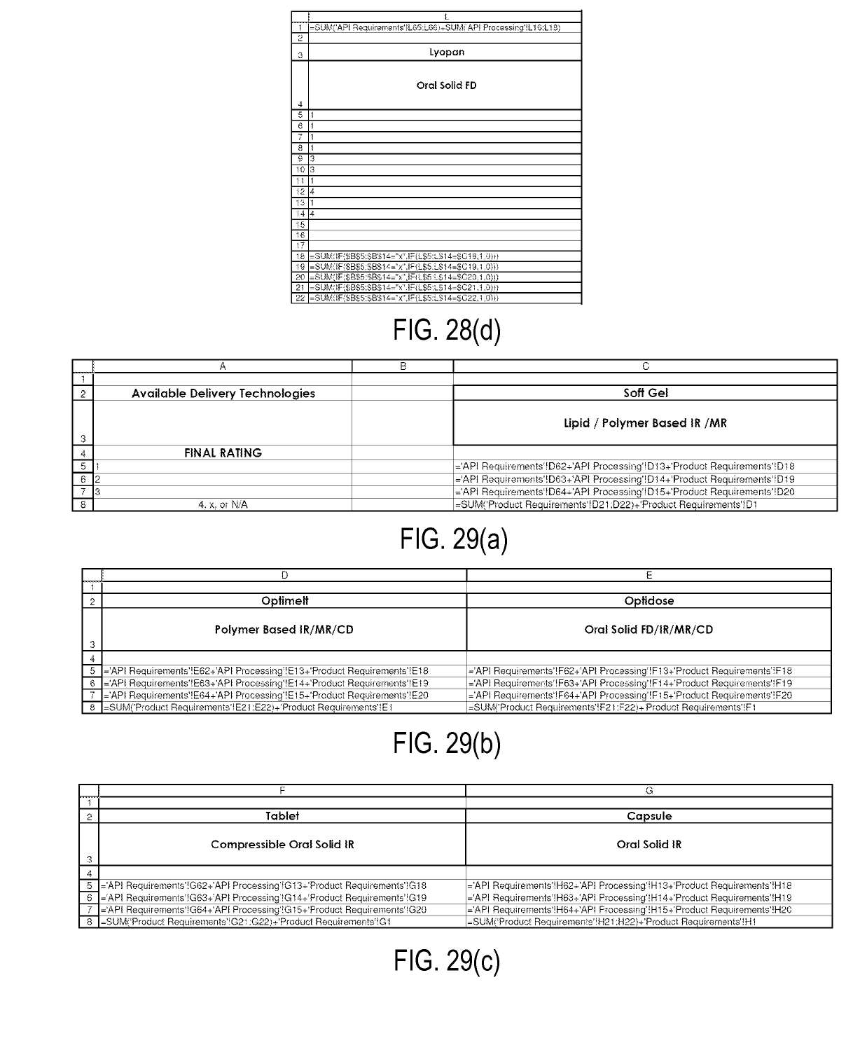

FIGS. 26(a)-(d) collectively show the “API Requirements” page, which is the first page of the four-page spreadsheet for implementing the exemplary method. FIGS. 27(a)-(c) collectively show the “API Processing” page, which is the second page of the four-page spreadsheet for implementing the exemplary method. FIGS. 28(a)-(d) collectively show the “Product Requirements” page, which is the third page of the four-page spreadsheet for implementing the exemplary method. FIGS. 28(a)-(e) collectively show the “Available Delivery Technologies” page, which is the fourth page of the four-page spreadsheet for implementing the exemplary method.

These four spreadsheet pages function together as a single spreadsheet, as follows. First, input information supplied by the potential customer (e.g., as provided via the web interface, as described above) is fed into the “API Requirements” page (FIGS. 26(a)-(d)) by entering appropriate selections under the “Choose 1” and “Yes” columns of FIG. 26(a). Next, input information supplied by the potential customer (e.g., as provided via the web interface, as described above) is fed into the “API Processing” page (FIGS. 27(a)-(c)) by entering appropriate selections under the “Choose All That Apply” column of FIG. 27(a). Next, input information supplied by the potential customer (e.g., as provided via the web interface, as described above) is fed into the “Product Requirements” page (FIGS. 28(a)-(d)) by entering appropriate selections under the “Choose All That Apply” column of FIG. 28(a). Next, the “Available Delivery Technologies” page of FIGS. 28(a)-(e) uses the supplied information from the three preceding spreadsheet pages to assign, to each of the eight available delivery technologies, a rating of 1 though 4, where 1 is the most appropriate, and 4 is the least appropriate, or a rating of “x” if a technology is not applicable. This assigned rating information is then used to provide and output in report form, as described above, the “best fit,” “potential solutions,” and “not an option” rankings to the various technologies, and sub-rankings within “best fit” and “potential solutions” categories. The threshold ranges and particular methods for determining “best fit,” “potential solutions,” and “not an option” will vary, in different embodiments.

A software tool consistent with certain embodiments of the disclosure can have all or certain portions be encrypted and/or password protected so that if a device executing or accessing the software (e.g., a laptop, scanner, smartphone, or the like) is lost or compromised, sensitive drug information cannot be used or accessed by third parties. In one embodiment, results/technology options are provided to customers of a drug-technology company only in a PDF format, securely.

It should be understood that, although the foregoing description refers to drug-delivery technologies in terms of tablets, capsules, and other oral-delivery mechanisms, a method consistent with other embodiments of the disclosure may be used to identify appropriate drug-delivery technologies other than those designed for ingestion, including those designed for inhalation, injection, infusion, absorption, and the like.

Although the details of the foregoing exemplary method have been provided in spreadsheet form for illustrative purposes, it should be recognized that the method could be implemented or embodied in other forms, such as program code, look-up tables, or the like. A method consistent with embodiments of the disclosure receives, as input, data including molecule characteristics and the like, and uses that data to identify and recommend one or more corresponding potential drug-delivery technologies.

### Alternative Embodiments

It should be understood that appropriate hardware, software, or a combination of both hardware and software is provided to effect the processing described above, in the various embodiments of the disclosure. It should further be recognized that a particular embodiment might support one or more of the modes of operation described herein, but not necessarily all of these modes of operation.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

It should be understood that various changes in the details, materials, and arrangements of the parts which have been described and illustrated in order to explain the nature of embodiments of the disclosure may be made by those skilled in the art without departing from the scope of the disclosure. For example, it should be understood that the inventive concepts of embodiments of the disclosure may be applied not only in systems for drug-delivery technology selection, but also in other related applications for which embodiments of the disclosure may have utility.

Embodiments of the present disclosure can take the form of methods and apparatuses for practicing those methods. Such embodiments can also take the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the disclosure. Embodiments of the disclosure can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the disclosure. When implemented on a general-purpose processor, the program code segments combine with the processor to provide a unique device that operates analogously to specific logic circuits.

It will be appreciated by those skilled in the art that although the functional components of the exemplary embodiments of the system described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present disclosure. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the disclosure as described herein may be implemented in one or more computers residing on a network transaction server system, and input/output access to embodiments of the disclosure may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the disclosure, in real-time and/or batch-type transactions. Likewise, a system consistent with the present disclosure may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, Google Chrome™, or Apple Safari™). Thus, embodiments of the present disclosure may be appropriately adapted to include such communication functionality and Internet browsing ability. Additionally, those skilled in the art will recognize that the various components of the server system of the present disclosure may be remote from one another, and may further include appropriate communications hardware/software and/or LAN/WAN hardware and/or software to accomplish the functionality herein described.

Each of the functional components of embodiments of the present disclosure may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the disclosure may be server-based and may reside on hardware supporting an operating system such as Microsoft Windows NT/2000™, Linux, or UNIX.

Components of a system consistent with embodiments of the disclosure may include mobile and non-mobile devices. Mobile devices that may be employed in embodiments of the present disclosure include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iOS operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the disclosure include 2.5G cellular network technologies such as GPRS and EDGE, as well as 3G technologies such as CDMA 1xRTT and WCDMA2000, and 4G technologies. Although mobile devices may be used in embodiments of the disclosure, non-mobile communications devices are also contemplated by embodiments of the disclosure, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to embodiments of the present disclosure. These personal computers may run the Unix, Microsoft Windows NT/2000™, Windows 95/98/NT/ME/CE/2000/XP/Vista/7™, or MacOS operating systems. The aforesaid functional components of a system according to the disclosure may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to embodiments of the present disclosure may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present disclosure to achieve additional functionality.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to embodiments of the present disclosure include Java, HTML, Perl, UNIX shell scripting, assembly language, Fortran, Pascal, Visual Basic, and QuickBasic. Those skilled in the art will recognize that embodiments of the present disclosure may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The singular terms “computer” or “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present invention. Thus, embodiments of the invention are intended to cover all such alternatives, modifications, and equivalents as may be included within the spirit and broad scope of the disclosure.

It should be understood that various changes in the details, materials, and arrangements of the parts which have been described and illustrated in order to explain the nature of this disclosure may be made by those skilled in the art without departing from the scope of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the disclosure has been set forth in terms of the exemplary embodiments described herein and illustrated in the attached drawings, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the disclosure be interpreted as encompassing all alterations, modifications, or alternative embodiments and applications as fall within the true spirit and scope of this disclosure.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A drug-delivery technology recommendation server adapted to perform a method for identifying one or more drug-delivery technologies, the method comprising:
(a) the processor receiving data associated with a drug molecule;
(b) the processor evaluating the data associated with the drug molecule with reference to stored characteristics of one or more drug-delivery technologies;
(c) based on the evaluation of step (b), the processor determining one or more drug-delivery technologies corresponding to the drug molecule; and
(d) the processor providing identification of the one or more determined drug-delivery technologies to an output device.

2. The server of claim 1, wherein the drug molecule comprises one or more vitamins, minerals, supplements, nutraceuticals, new chemical entities, chemical compounds, polymers, bulk intermediates, the active ingredient of generic drug products, 505B2 drug products, over the counter (OTC) drug products, brand drug products, consumer products, cosmetic products, oral vaccine products and biosimilar drug products.

3. The server of claim 1, wherein the server is adapted to combine information on multiple drug molecules to identify one or more drug delivery technologies for combination drug molecules.

4. The server of claim 1, wherein the server is adapted to receive and use publicly available data associated with a drug molecule to perform step (c).

5. The server of claim 1, wherein the server is adapted to provide one or more drug-delivery technologies for drug molecules to be filed as 505B2 drug products, generic drug products or ANDA's, sNDA's, branded drug products or NDA's and OTC drug products.
